(19) United States
(12) Patent Application Publication
(10) Pub. No.: US 2012/0102681 A1
(43) Pub. Date: May 3, 2012

(54) Novel apparel clip for manual and hard surface device dockage

(75) Inventor: Arlette Sieger, Port Washington, NY (US)

(73) Assignee: Arlertte Sieger, Port Washington, NY (US)

(21) Appl. No.: 12/938,388

(22) Filed: Nov. 3, 2010

(51) Int. Cl. F16B 47/00; F16B 2/20; F16B 45/02

(52) U.S. Cl. 24/304

(57) ABSTRACT

The disclosure describes a docking device for hand tool, and devices which can be attached to clothing or an adhesively backed docking stud. The device contains both carabiner and alligator clips elements simultaneously in the same device.

### OBJECTS OF THE INVENTION

One object of the device is to develop a novel removable clip for manual device attachment. Another object of the device is to produce a removable novel device clip which is lightweight and allows for ease of attachment and detachment in an lock-and unlock format. Another object of the invention is to have a carabiner clip. Another object of the invention is to have a fixed loop with a jump ring. Yet another object of the invention is to combine the two aforementioned features with an alligator clip.

### BRIEF DESCRIPTION OF THE DRAWINGS

While this specification concludes with claims particularly pointing out and distinctly claiming that which is regarded as forming the present invention, it is anticipated that the invention can be more readily understood through reading the following detailed description of the invention and study of the accompanying drawings.

FIG. 1 Side of view of invention with hinged clip (left) and slide clip (right) showing the relative position of each element of the invention to the other.

FIG. 2 View of invention (hinge clip side) with attachment loop (top) and sliding clasp (bottom). The opening for adhesive tab is located towards the center.

FIG. 3 View of invention (hinge clip side) with sliding clasp closed (left) and open (right).

FIG. 4 View of invention (slide clip side) with sliding clasp closed (left) and open (right).

FIG. 5 Side of view of invention with hinged clip closed (left) and open (right).

FIG. 6 Exploded view of invention (from left to right),

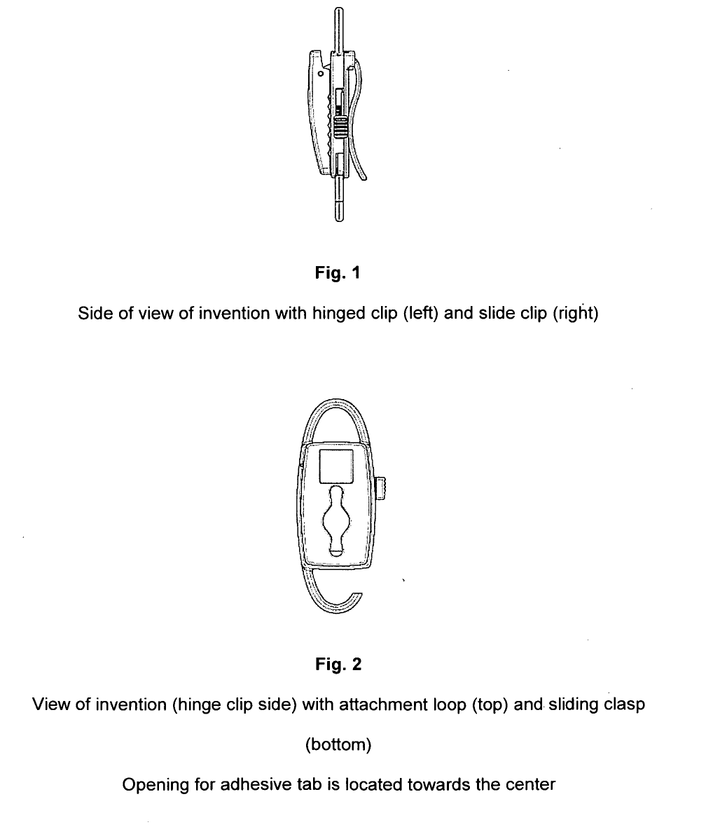

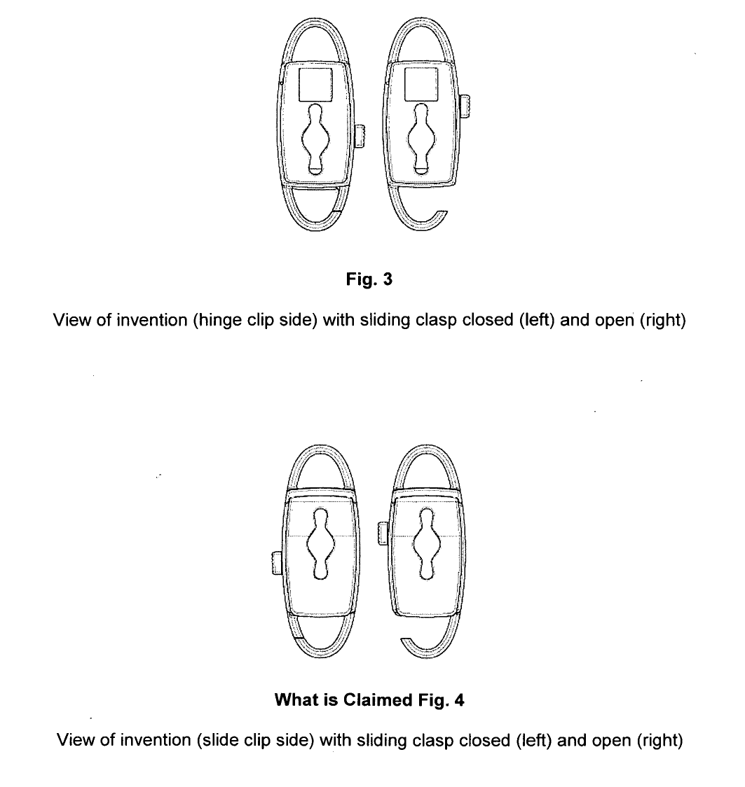

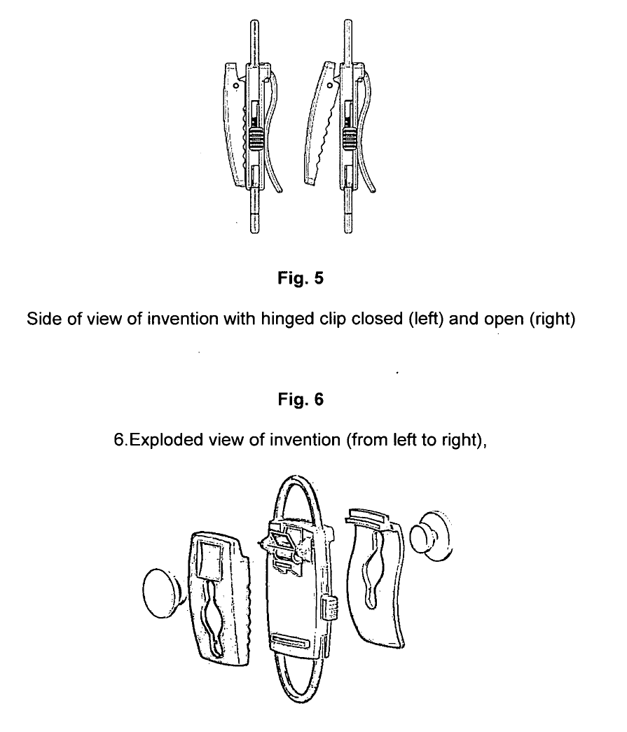

### DETAILED DESCRIPTION OF THE INVENTION

An injection molded plastic or machined or cast metal clip is comprised of upper and lower loops or “sliding clasps” which serve as attachment points respectively and open and close on spring fed tracks. The upper loop is typically closed and serves at an attachment for a jump ring. The lower loops close when not under tension. The loops are opened and closed by a manually operated clasp lever which is designed for thumb use. In addition this upper and lower loop device sits in one face of an alligator style clip. On the other side of this clip are grooved slots into which the attachment stud inserts.

1) A clothing or tool holding device which is comprised an adhesive tab, hinged clip, base, slide clip, and adhesive tab which includes a carabiner clip, as well as a fixed loop with a jump ring and an alligator clip in one attachment device. In addition the device is slotted on the back face of the clip for attachment studs so that an adhesive backed stud can serve as a rack for the device when it is not used as clothing apparel. The alligator clip can be in line with, or reverse-alligned 180 degrees with the slip-on element. There is also a stud attached chord with a sliding lock which can act as an attachment for objects and tools. This serves to secure objects within the sliding lock.

2) The claim in 1 where the device is made from aluminum.

3) The claim in 1 where the device is made from thermoplastic polymer

4) The claim in where the device is made from thermo-set polymer.

5) The claim in 2 where the device is made by sintering

6) The claim in 2 where the device is made by spin casting components.

7) The claim in 2 where the device is made by machining the parts.

8) The claim in 1 where the device is made from steel alloy.

9) The claim in 9 where the device is made from titanium alloy.

10) The claim in 8 where the device is carbon, stainless or silicon or berylium steel.

11) The claim in 3 where the thermoplastic polymer is acetyl-butyl-styrene(ABS)

12) The claim in 3 where the thermoplastic polymer is a polyamide.

13) The claim in 3 where the thermoplastic polymer is a polyimide.

14) The claim in 3 where the thermoplastic polymer is polycarbonate

17) The claim in 3 where the thermoplastic polymer is glass or fiber filled from 5 to 10% w/w.

18) The claim in 3 where the thermoplastic polymer is injection molded.

19) The claims in 1 where any and all materials and processes in claims 1-18 have been made.

20) The claims in 1 where the device is made from resin-based fiber composite
